(19) United States
(12) Patent Application Publication
(10) Pub. No.: US 2010/0079400 A1
(43) Pub. Date: Apr. 1, 2010

(54) TOUCH SENSITIVE DISPLAY WITH CONDUCTIVE LIQUID

(75) Inventor: Bengt Fredrik NISSAR, Stockholm (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/238,573

(22) Filed: Sep. 26, 2008

(51) Int. Cl. G06F 3/045

(52) U.S. Cl. 345/174

(57) ABSTRACT

A mobile communication device may include a touch sensitive display assembly comprising a display for displaying information, a top substrate that includes a number of column electrodes, a bottom substrate that includes a number of row electrodes, and a conducting liquid between the top substrate and the bottom substrate. The mobile communication device further includes logic configured to determine a position of an input on the top substrate based on a change of current in at least one of the number of column electrodes and at least one of the number of row electrodes and cause the display to display information based on the determined position of input on the top substrate.

### BACKGROUND OF THE INVENTION

Implementations described herein relate generally to input devices, and more particularly, to handheld touch sensitive input devices.

Devices, such as handheld mobile communication devices, conventionally include touch sensitive input devices. Conventional touch sensitive displays are usually formed with either a resistive or capacitive film layer located above an input display that is used to sense a touch of the user's finger or stylus. Currently, both the resistive and capacitive methods have drawbacks that hinder touch inputs. For example, resistive films reduce the performance of the display and do not allow for multi-touch inputs, while capacitive films do not allow for stylus inputs.

### SUMMARY OF THE INVENTION

According to one aspect, a mobile communication device is provided. The mobile communication device may include a touch sensitive display assembly including: a display for displaying information; a top substrate that includes a number of column electrodes; a bottom substrate that includes a number of row electrodes; and a conducting liquid between the top substrate and the bottom substrate; and logic configured to: determine a position of an input on the top substrate based on a change of current in at least one of the number of column electrodes and at least one of the number of row electrodes, and cause the display to display information based on the determined position of the input on the top substrate.

Additionally, the change of current in at least one of the number of column electrodes and at least one of the number of row electrodes is produced when a user presses down on the top substrate.

Additionally, the change of current in at least one of the number of column electrodes and at least one of the number of row electrodes is produced by decreasing a resistance of the conducting liquid between the at least one of the number of column electrodes and the at least one of the number of row electrodes.

Additionally, a distance between the at least one of the number of column electrodes and the at least one of the number of row electrodes decreases.

Additionally, the logic may be further configured to determine the position of input by identifying a position of the at least one of the number of column electrodes and identifying a position of the at least one of the number of row electrodes.

According to another aspect, a method may be provided. The method may comprise determining a change of current in at least one of a number of column electrodes and at least one of a number of row electrodes, where the determined change of current is produced when the at least one of a number of column electrodes is moved closer to the least one of a number of row electrodes; determining a position of an input on a surface of a display based on identifying a position of the at least one of a number of column electrodes and a position of the least one of a number of row electrodes; and activating a display to display information based on the determined position of the input.

Additionally, the at least one of a number of column electrodes is moved closer to the least one of a number of row electrodes when a user presses down on the surface.

Additionally, the determined change of current in at least one of a number of column electrodes and at least one of a number of row electrodes is an increase of current.

Additionally, the increase of current is produced by a decreased resistance between the at least one of a number of column electrodes and the least one of a number of row electrodes.

Additionally, current flows through a conducting liquid and the at least one of a number of column electrodes and the least one of a number of row electrodes.

According to yet another aspect, a device may comprise means for displaying information on a surface; means for determining a position of an input on the surface by monitoring current through a conducting liquid located beneath the surface; and means for displaying a character based on the determined position of the input.

Additionally, the means for displaying information includes a liquid crystal display (LCD).

Additionally, the means for determining a position of input on the surface includes a number of column electrodes and a number of row electrodes.

Additionally, the means for determining a position of input on the surface includes: means for identifying a position of a column electrode and a position of a row electrode.

Additionally, the means for determining a position of input on the surface includes: means for determining an amount of current through the number of column electrodes and the number of row electrodes.

According to yet another aspect, a device may comprise a touch sensitive display assembly comprising: a display, a top substrate including a number of column electrodes; a bottom substrate including a number of row electrodes; and logic configured to: determine an input position on the top substrate based on an increase of current through one of the column electrodes and an increase of current through one of the row electrodes, and control the display to display information based on the determined input position.

Additionally, the device may further comprise a conducting liquid between the column electrodes and the row electrodes.

Additionally, a resistance provided by the conducting liquid decreases when the one of the column electrodes is moved closer to the one of the row electrodes.

Additionally, the logic may be further configured to: determine an amount of current through each of the number of column electrodes and the number of row electrodes.

Additionally, the logic may be further configured to: compare the determined amount of current through each of the number of column electrodes and the number of row electrodes to a predetermined value of current.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary implementation of a mobile terminal;

FIG. 2 illustrates an exemplary functional diagram of a mobile terminal;

FIG. 3 illustrates an exemplary functional diagram of the display logic of FIG. 2;

FIGS. 4A-4D illustrate an exemplary display assembly;

FIG. 5 is a flowchart of exemplary processing; and

FIGS. 6-7 illustrate an example of the processing described in FIG. 5.

### DETAILED DESCRIPTION OF THE INVENTION

The following detailed description of the invention refers to the accompanying drawings. The same reference numbers in different drawings may identify the same or similar elements. Also, the following detailed description does not limit the embodiments.

Exemplary implementations of the embodiments will be described in the context of a mobile communication terminal. It should be understood that a mobile communication terminal is an example of a device that can employ a display consistent with the principles of the embodiments and should not be construed as limiting the types or sizes of devices or applications that can use implementations of displays described herein. For example, displays consistent with the principles of the embodiments may be used on desktop communication devices, household appliances, such as microwave ovens and/or appliance remote controls, automobile radio faceplates, televisions, computer screens, industrial devices, such as testing equipment, etc.

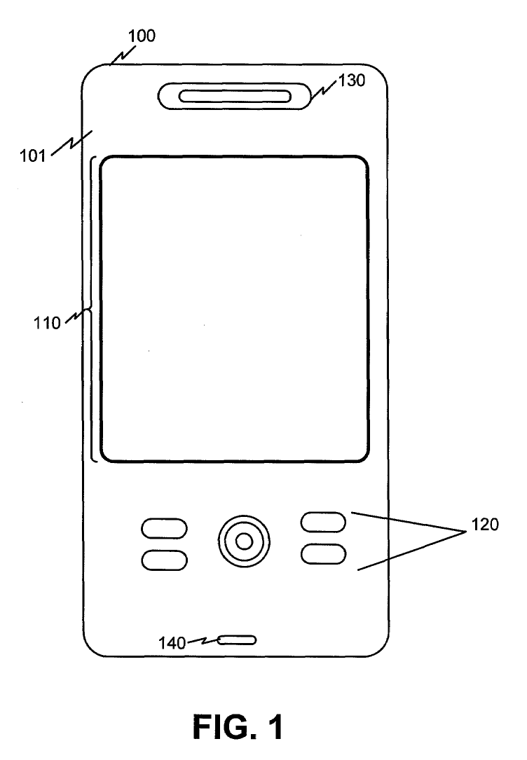

FIG. 1 is a diagram of an exemplary implementation of a mobile terminal consistent with exemplary embodiments. Mobile terminal 100 (hereinafter terminal 100) may be a mobile communication device. As used herein, a “mobile communication device” and/or “mobile terminal” may include a radiotelephone; a personal communications system (PCS) terminal that may combine a cellular radiotelephone with data processing, a facsimile, and data communications capabilities; a personal digital assistant (PDA) that can include a radiotelephone, pager, Internet/intranet access, web browser, organizer, calendar, and/or global positioning system (GPS) receiver; and a laptop and/or palmtop receiver or other appliance that includes a radiotelephone transceiver.

Terminal 100 may include housing 101, display area 110, control keys 120, speaker 130 and microphone 140. Housing 101 may include a structure configured to hold devices and components used in terminal 100. For example, housing 101 may be formed from plastic, metal, or a composite and may be configured to support display area 110, control keys 120, speaker 130 and microphone 140.

Display area 110 may include devices and/or logic that can be used to display images to a user of terminal 100 and to receive user inputs in association with the displayed images. For example, characters and icons may be displayed via display area 110. Display area 110 may also provide information regarding incoming or outgoing calls, text messages, games, phone books, the current date/time, volume settings, etc., to a user of terminal 100. Implementations of display area 110 may be configured to receive a user input when the user touches display area 110. For example, the user may provide an input to display area 110 directly, such as via the user's finger, or via other devices, such as a stylus. User inputs received via display area 110 may be processed by components or devices operating in terminal 100.

In one implementation, display area 110 may be covered by a single plate of glass, plastic or other material which covers a display. Display area 110 may display information, such as numbers, letters, symbols, icons, etc. A user may interact with display area 110 to input information into terminal 100. For example, a user may enter digits, commands, and/or text, into terminal 100. In one embodiment, information displayed via in display area 110 may be displayed via a liquid crystal display (LCD).

Control keys 120 may include buttons that permit a user to interact with terminal 100 to cause terminal 100 to perform an action, such as to display a text message via display area 110, raise or lower a volume setting for speaker 130, etc.

Speaker 130 may include a device that provides audible information to a user of terminal 100. Speaker 130 may be located in an upper portion of terminal 100 and may function as an ear piece when a user is engaged in a communication session using terminal 100. Speaker 130 may also function as an output device for music and/or audio information associated with games and/or video images played on terminal 100.

Microphone 140 may include a device that converts speech or other acoustic signals into electrical signals for use by terminal 100. Microphone 140 may be located proximate to a lower side of terminal 100 and may be configured to convert spoken words or phrases into electrical signals for use by terminal 100.

Although FIG. 1 shows exemplary components of terminal 100, in other implementations, terminal 100 may contain fewer, different, or additional components than depicted in FIG. 1. In still other implementations, one or more components of terminal 100 may perform one or more of the functions described as performed by one or more other components of terminal 100.

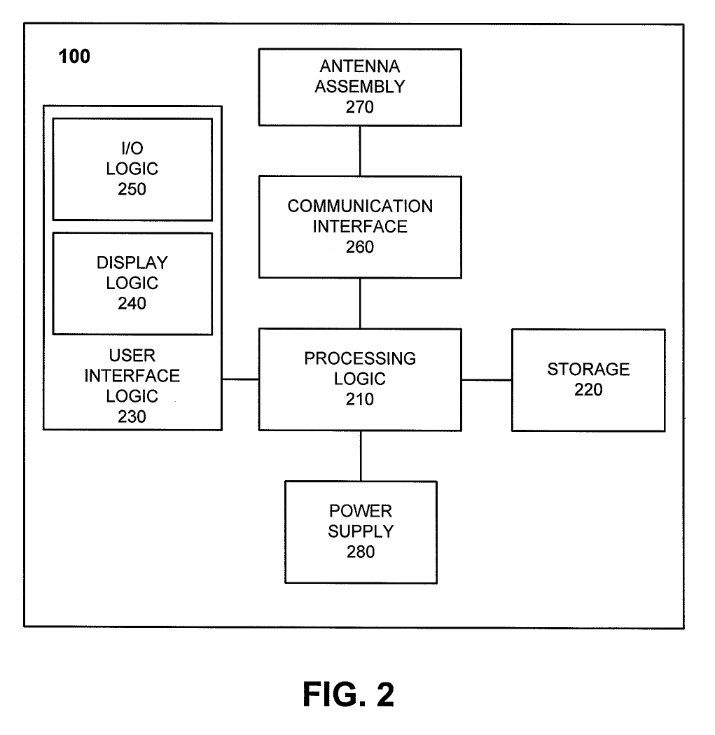

FIG. 2 illustrates an exemplary functional diagram of mobile terminal 100 consistent with the principles described herein. As shown in FIG. 2, terminal 100 may include processing logic 210, storage 220, user interface logic 230, display logic 240, input/output (I/O) logic 250, communication interface 260, antenna assembly 270, and power supply 280.

Processing logic 210 may include a processor, microprocessor, an application specific integrated circuit (ASIC), field programmable gate array (FPGA), or the like. Processing logic 210 may process data structures or software programs to control operation of terminal 100 and its components. Implementations of terminal 100 may use an individual processing logic component or multiple processing logic components (e.g., multiple processing logic 210 devices), such as processing logic components operating in parallel. Storage 220 may include a random access memory (RAM), a read only memory (ROM), a magnetic or optical disk and its corresponding drive, and/or another type of memory to store data and instructions that may be used by processing logic 210.

User interface logic 230 may include mechanisms, such as hardware and/or software, for inputting information to terminal 100 and/or for outputting information from terminal 100. In one implementation, user interface logic 230 may include display logic 240 and input/output logic 250.

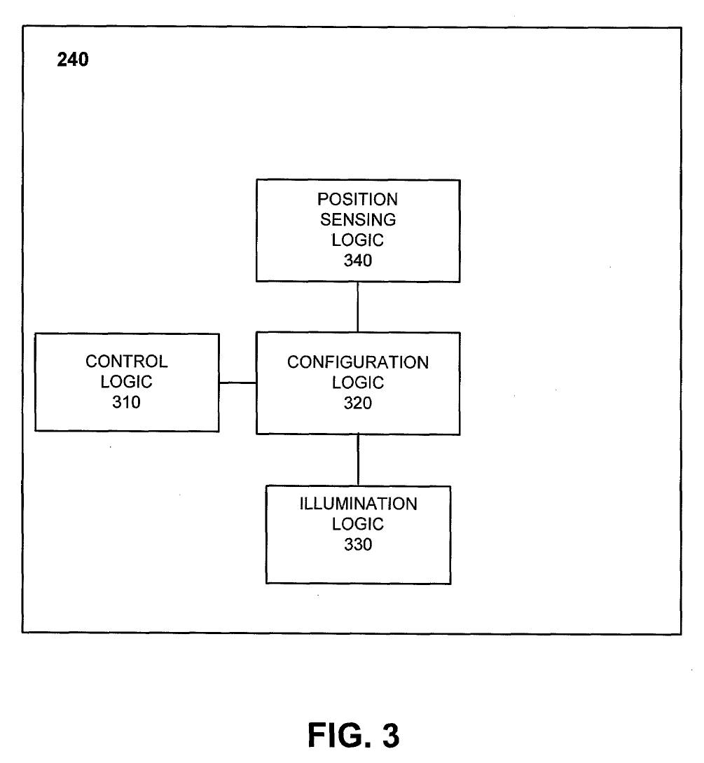

Display logic 240 may include mechanisms, such as hardware and/or software, used to control the appearance of display area 110 and to receive user inputs via display area 110. For example, display logic 240 may cause information to be displayed on an LCD display. In some implementations, display logic 240 may be application controlled and may automatically re-configure the appearance of display area 110 based on an application being launched by the user of terminal 100, the execution of a function associated with a particular application/device included in terminal 100 or some other application or function specific event. For example, display logic 240 may control the appearance of display area 110 to display icons, may receive an input, and then re-configure the appearance of display area 110 to display numeric keys. Display logic 240 is described in greater detail below with respect to FIG. 3.

Input/output logic 250 may include hardware or software to accept user inputs to make information available to a user of terminal 100. Examples of input and/or output mechanisms associated with input/output logic 250 may include a speaker (e.g., speaker 130) to receive electrical signals and output audio signals, a microphone (e.g., microphone 140) to receive audio signals and output electrical signals, buttons (e.g., control keys 120) to permit data and control commands to be input into terminal 100.

Communication interface 260 may include, for example, a transmitter that may convert base band signals from processing logic 210 to radio frequency (RF) signals and/or a receiver that may convert RF signals to base band signals. Alternatively, communication interface 260 may include a transceiver to perform functions of both a transmitter and a receiver. Communication interface 260 may connect to antenna assembly 270 for transmission and reception of the RF signals. Antenna assembly 270 may include one or more antennas to transmit and receive RF signals over the air. Antenna assembly 270 may receive RF signals from communication interface 260 and transmit them over the air and receive RF signals over the air and provide them to communication interface 260.

Power supply 280 may include one or more power supplies that provide power to components of terminal 100. For example, power supply 280 may include one or more batteries and/or connections to receive power from other devices, such as an accessory outlet in an automobile, an external battery, or a wall outlet. Power supply 280 may also include metering logic to provide the user and components of terminal 100 with information about battery charge levels, output levels, power faults, etc.

As will be described in detail below, terminal 100, consistent with the principles described herein, may perform certain operations relating to receiving inputs via display area 110 in response to user inputs. Terminal 100 may perform these operations in response to processing logic 210 executing software instructions and/or a configuration/reprogramming application contained in a computer-readable medium, such as storage 220. A computer-readable medium may be defined as a physical or logical memory device.

The software instructions may be read into storage 220 from another computer-readable medium or from another device via communication interface 260. The software instructions contained in storage 220 may cause processing logic 210 to perform processes that will be described later. Alternatively, hardwired circuitry may be used in place of or in combination with software instructions to implement processes consistent with the principles described herein. Thus, implementations consistent with the principles of the embodiments are not limited to any specific combination of hardware circuitry and software.

Although FIG. 2 shows exemplary components of terminal 100, in other implementations, terminal 100 may contain fewer, different, or additional components than depicted in FIG. 2. In still other implementations, one or more components of terminal 100 may perform one or more of the functions described as performed by one or more other components of terminal 100.

FIG. 3 illustrates an exemplary functional diagram of display logic 240 consistent with the principles of the embodiments. Display logic 240 may include control logic 310, configuration logic 320, illumination logic 330 and position sensing logic 340.

Control logic 310 may include logic that controls the operation of configuration logic 320, and receives signals from position sensing logic 340. Control logic 310 may determine and process an input based on the displayed information from configuration logic 320 and received signals from position sensing logic 340. Control logic 310 may be implemented as standalone logic or as part of processing logic 210. Moreover, control logic 310 may be implemented in hardware and/or a combination of hardware and software.

Configuration logic 320 may include logic and/or devices to present information via display area 110. Configuration logic 320 may include processing logic to interpret signals and instructions and a display device having a display area to provide information. Implementations of configuration logic 320 may include a liquid crystal display (LCD) that includes, for example, biphenyl or another stable liquid crystal material. Configuration logic 320 may change information displayed via display area 110. For example, configuration logic 320 may control display area 110 to display a number of icons or a numeric keypad, for example.

Illumination logic 330 may include logic to provide backlighting to a lower surface of display area 110 in order to display information. Illumination logic 330 may also provide backlighting to be used with LCD based implementations of configuration logic 320 to make images brighter and to enhance the contrast of displayed images. Implementations of illumination logic 330 may employ light emitting diodes (LEDs) or other types of devices to illuminate portions of a display device. Illumination logic 330 may provide light within a narrow spectrum, such as a particular color, or via a broader spectrum, such as full spectrum lighting. Illumination logic 330 may also be used to provide front lighting to an upper surface of display area 110 that faces a user. Front lighting may enhance the appearance of display area 110 by making information more visible in high ambient lighting environments, such as viewing a display device outdoors.

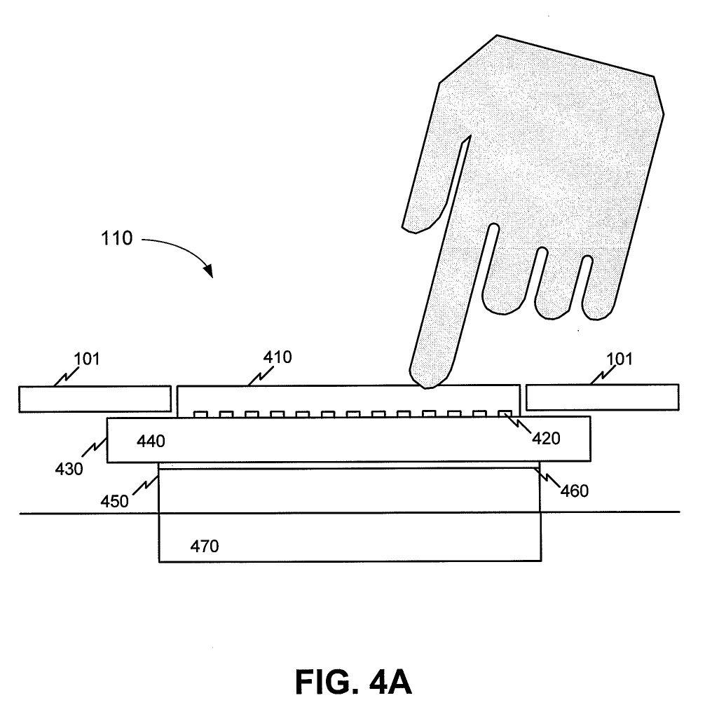

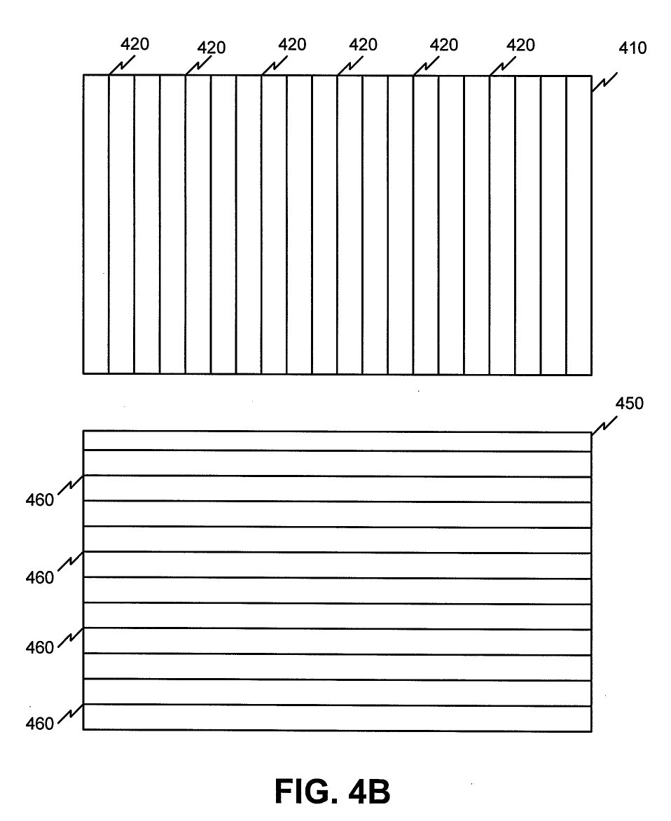

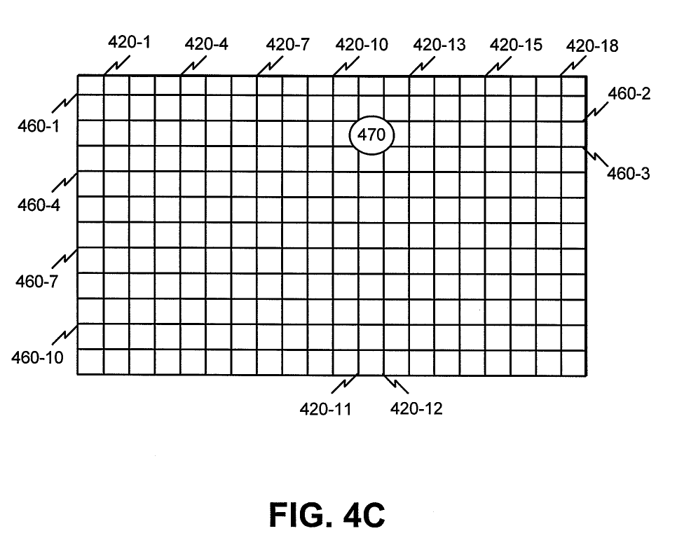

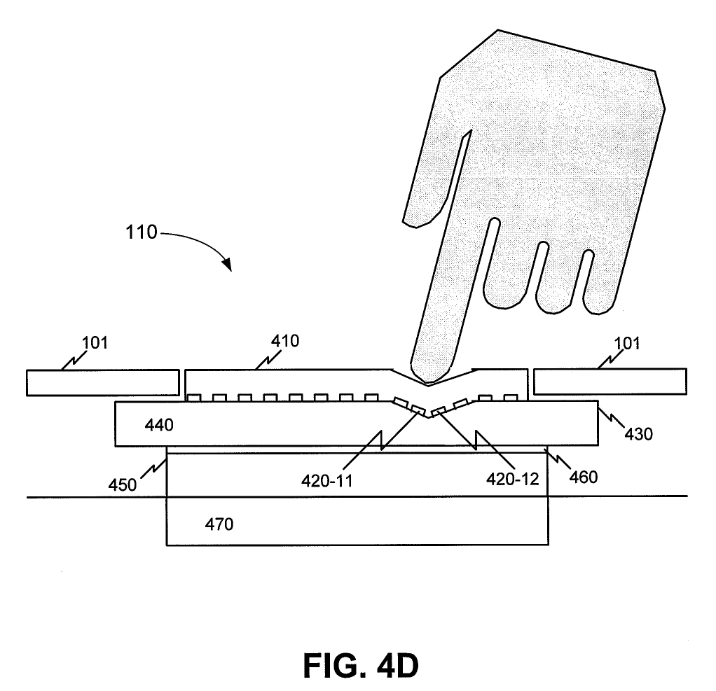

Position sensing logic 340 may include logic that senses the position and/or presence of an object within display area 110. For example, position sensing logic 340 may be configured to determine a location in display area 110 where a user places his/her finger. Further, position sensing logic 340 may be configured to determine how much pressure the user exerts on display area 110. In one implementation for example, position sensing logic 340 may include a number of column electrodes, a number of row electrodes and an electrically conducting liquid between the column and row electrodes. Position sensing logic 340 may also include logic to provide and monitor current through the electrodes. A change in current through the electrodes (both column and row) may be detected by position sensing logic 340 to determine a location where a user is touching display area 110, for example. For example, assume that a user presses on the upper left hand corner of display area 110. The current through column and row electrodes located directly underneath this point may change as a result of the applied pressure. Position sensing logic 340 may identify the position of the specific electrodes which changed an amount of current and based on which electrodes were identified, determine a location of the user's, for example. By determining the amount of change in current and determining which electrodes changed current, position sensing logic 340 may determine how hard a user is pressing on display area 110. For example, a user may press with 10 to 300 grams of force. Additionally, by determining the amount of change in current and determining which electrodes changed current, position sensing logic 340 may determine a position of input at a higher resolution than the spacing between the electrodes. Position sensing logic 340 may also include logic that communicates with configuration logic 320 and/or control logic 310 to determine and process inputs based on detecting the position and/or presence of an object within display area 110 and the information displayed within display area 110. Further details of position sensing logic 340 are illustrated in FIGS. 4A to 4D.

Although FIG. 3 shows exemplary components of display logic 240, in other implementations, display logic 240 may contain fewer, different, or additional components than depicted in FIG. 3. In still other implementations, one or more components of display logic 240 may perform one or more of the functions described as performed by one or more other components of display logic 240.

FIGS. 4A to 4D illustrate an exemplary display assembly and input system within display area 110. As shown in FIG. 4A, display area 110 may include housing 101, top substrate 410 which includes a number of column electrodes 420, enclosure 430, conducting liquid 440, bottom substrate 450 which includes a number of row electrodes 460 and display screen 470.

As described above, housing 101 may include a hard plastic material used to mount components within terminal 100. In one embodiment, top substrate 410 may be mounted in housing 101 within display area 110.

Top substrate 410 may include a single sheet of a transparent flexible substrate, such as a thin sheet of glass, for example, which may cover components within display area 110. In one example, the thickness of the glass may be 0.1 to 0.2 millimeters. In other embodiments, top substrate 410 may include other materials, such as a plastic or composite material, a thin PPMA or a PET film. In each case, top substrate 410 may include a surface, (e.g., a single surface) located over display area 110, that is formed as part of display area 110. As described above, top substrate 410 may include a number of column electrodes 420 located on the bottom surface of top substrate 410.

Column electrodes 420 may include a number of electrodes arranged in columns across the bottom surface of top substrate 410. Current may be applied to column electrodes 420 via, for example, position sensing logic 340. Although shown in FIGS. 4A-4D, it should be understood that column electrodes 420 may be formed of a transparent substance, such as Indium Tin Oxide, so as to allow light emitted from display screen 470 to pass up through top substrate 410 and be visible to the user.

Enclosure 430 may include an enclosed area for holding or containing conducting liquid 440. For example, enclosure 430 may be formed of a clear plastic material. Enclosure 430 may contact the bottom surface of top substrate 410 and the top surface of bottom substrate 450.

Conducting liquid 440 may include any type of conducting liquid, mixture or gel. Conducting liquid 440 may be used to provide an electrically conductive medium in which to transmit electrical current between column electrodes 420 and row electrodes 460. Conducting liquid 440 may have a particular resistivity, which gives a particular resistance value between a column electrode 420 and a row electrode 460. In one example, conducting liquid 440 may provide a resistance of 1000 Ohms per inch. Continuing with this example, if enclosure 430 is one inch deep, the resistance provided by conducting liquid 440 may be 1000 Ohms between column electrodes 420 and row electrodes 460, when top substrate 410 is not depressed. If for example, top substrate 410 is depressed by a user and the distance between column electrodes 420 and row electrodes 460 becomes one half inch, the resistance (provided by conducting liquid 440) between column electrodes 420 and row electrodes 460 will be 500 Ohms. The optical index of conducting liquid 440 may also be matched to the index of the other surfaces, (top substrate 410 and bottom substrate 450) so as to not cause internal reflections of light.

Bottom substrate 450 may include a single sheet of a transparent substrate, such as a thin film of glass, for example. In one example, the thickness of the glass may be 0.1 to 0.2 millimeters. In other embodiments, bottom substrate 450 may include other materials, such as a plastic or composite material, such as a thin PPMA or a PET film. Bottom substrate 450 may include row electrodes 460 located on the top surface of bottom substrate 410.

Row electrodes 460 may include a number of electrodes arranged in rows across the top surface of bottom substrate 450. Current may be applied and/or sensed to row electrodes 460 via, for example, position sensing logic 340. As mentioned above, although shown in FIGS. 4A-4D, it should be understood that row electrodes 460 may be formed of a transparent substance, such as Indium Tin Oxide, so as to allow light emitted from display screen 470 to pass up through bottom substrate 450 and top substrate 410 and be visible to the user.

Display screen 470 may include an LCD or similar type of display. Display screen 470 may display information based on signals received from configuration logic 320. Display screen 470 may display icons and/or other types of information, which may be seen by a user through top substrate 410. In other examples, display screen 470 may include OLEDs or Epaper.

FIG. 4B shows a top view of top substrate 410 and a top view of bottom substrate 450. As shown, top substrate 410 may include a number of evenly spaced column electrodes 420. Similarly, bottom substrate 450 may include a number of evenly spaced row electrodes 460.

FIG. 4C shows a top view of top substrate 410 placed directly above bottom substrate 450. Area 470 may represent an area touched by a user's finger on display area 110. As shown, column electrodes 420 and row electrodes 460 form a grid-like pattern. In this example, column electrodes 420-11 and 420-12 may be moved down closer toward row electrodes 460-2 and 460-3 when a user presses down on top substrate 410 to enter information via keypad area 110.

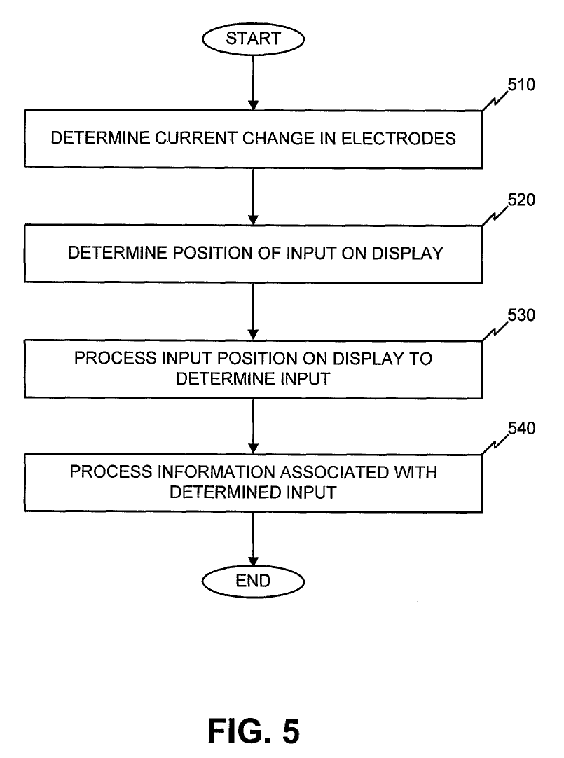

FIG. 4D shows a side view of display area 110 when touched by a user. When a user presses down on top substrate 410, column electrodes 420-11 and 420-12 may be moved closer to bottom substrate 450 and row electrodes 460. Operation of the display input system shown in FIGS. 4A-4D is described below with reference to FIG. 5.

FIG. 5 is a flowchart of exemplary processing consistent with the principles described herein. Terminal 100 may provide a display assembly as shown in FIG. 1 and FIGS. 4A-4D. Processing may begin when a change of current through electrodes is determined (block 510). As described above, position sensing logic 340 may provide voltage/current to column electrodes 420 and may monitor the amount of current passing through column electrodes 420 and row electrodes 460. A shown in FIG. 4A, if a user has not changed the distance between column electrodes 420 and row electrodes 460, if a 1 Volt signal is applied to column electrodes 420, and if the resistance of conducting liquid 440 is 1000 Ohms, a current of 0.001 Amps (1 miliamp) may be sensed through column electrodes 460 by position sensing logic 340. As shown in FIG. 4D, when a user presses down on top substrate 410 and decreases the distance (e.g., to half the original distance between column electrodes 420 and row electrodes 460) between column electrodes 420 and row electrodes 460, the resistance (of conducting liquid 440) between column electrodes 420 and row electrodes 460 decreases to 500 Ohms, and a current of 2 miliamps is sensed by position sensing logic 340 (block 510). Specifically in this example, column electrodes 420-11 and 420-12 may be moved in a downward direction closer toward row electrodes 460-2 and 460-3, and a current of 2 miliamps may be sensed through column electrodes 420-11 and 420-12 and row electrodes 460-2 and 460-3. In this example, by comparing the 2 miliamps of current sensed through column electrodes 420-11 and 420-12 and row electrodes 460-2 and 460-3 to a predetermined value of 1 miliamp of current, position sensing logic 340 may determine an electrical current change in the electrodes.

While a user's finger is touching display area 110, position sensing logic 340 may determine a position of input on the display (block 520). For example, as described above, position sensing logic 340 may sense a current of 2 miliamps through column electrodes 420-11 and 420-12 and row electrodes 460-2 and 460-3 and determine the position of input on display area 110. For example, position sensing logic 340 may include information relating to the grid-like pattern of column electrodes 420 and row electrodes 460 (as shown in FIG. 4C) which enables position sensing logic 340 to determine the position of input on display area 110 based on the specific electrodes that are monitored to show an increase in current.

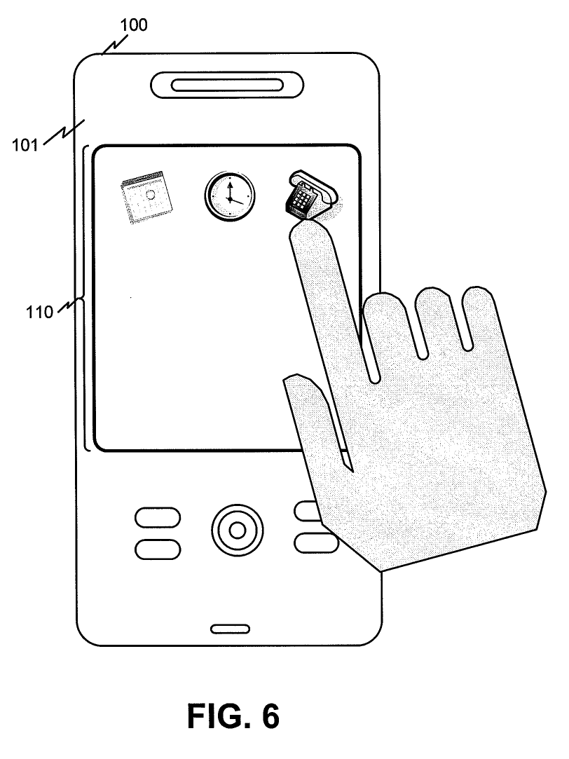

After determining the position of input on display area 110, the sensed position signal may be processed to determine an input (block 530). As shown in FIG. 6 for example, configuration logic 320 may provide icons within display area 110. In response to the received signals from position sensing logic 340, control logic 310 may determine that a user has pressed a displayed telephone icon in order to place a phone call.

In response to determining the input (block 530), the associated information with the determined input may be processed (block 540). For example, if position sensing logic 340 determines that a telephone icon is actuated (touched), a signal may be sent to control logic 310 and to configuration logic 320 in order to provide a numeric keypad via display area 110 to be used for entering a telephone number.

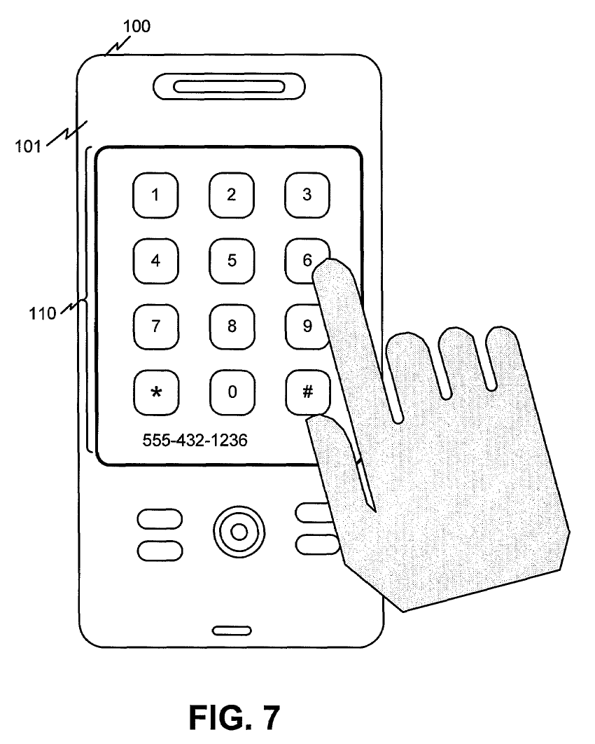

Continuing with this example, as shown in FIG. 7, a user may now touch numeric keys displayed within display area 110 in order to dial a telephone number. As described above, a user's finger may be sensed by a change in current through column electrodes 420 and row electrodes 460 (block 510) and the position of the user's finger within display area 110 may be determined by position sensing logic 340 (block 520). Based on the current information displayed via display screen 470, configuration logic 320 and control logic 310 may then determine the user input (block 530) and process the input (block 540). In this example, the determined input is a phone number dialed by the user, which may also be displayed via display area 110.

### CONCLUSION

Implementations consistent with the principles described herein may provide a touch sensitive display that includes a conducting liquid and logic to determine a position of input based on a current flowing between a number of column electrodes and a number of row electrodes.

The foregoing description of the embodiments provides illustration and description, but is not intended to be exhaustive or to limit the embodiments to the precise form disclosed. Modifications and variations are possible in light of the above teachings or may be acquired from practice of the embodiments.

While a series of acts has been described with regard to FIG. 5, the order of the acts may be modified in other implementations consistent with the principles of the embodiments. Further, non-dependent acts may be performed in parallel.

It will be apparent to one of ordinary skill in the art that aspects of the embodiments, as described above, may be implemented in many different forms of software, firmware, and hardware in the implementations illustrated in the figures. The actual software code or specialized control hardware used to implement aspects consistent with the principles of the embodiments is not limiting of the embodiments. Thus, the operation and behavior of the aspects were described without reference to the specific software code—it being understood that one would be able to design software and control hardware to implement the aspects based on the description herein.

Further, certain portions of the embodiments may be implemented as “logic” that performs one or more functions. This logic may include hardware, such as hardwired logic, an application specific integrated circuit, a field programmable gate array or a microprocessor, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A mobile communication device, comprising:
a touch sensitive display assembly comprising:
a display for displaying information;
a top substrate that includes a plurality of column electrodes;
a bottom substrate that includes a plurality of row electrodes; and
a conducting liquid between the top substrate and the bottom substrate; and
logic configured to:
determine a position of an input on the top substrate based on a change of current in at least one of the plurality of column electrodes and at least one of the plurality of row electrodes, and
cause the display to display information based on the determined position of the input on the top substrate.

2. The mobile communication device of claim 1, where the change of current in at least one of the plurality of column electrodes and at least one of the plurality of row electrodes is produced when a user presses down on the top substrate.

3. The mobile communication device of claim 2, where the change of current in at least one of the plurality of column electrodes and at least one of the plurality of row electrodes is produced by decreasing a resistance of the conducting liquid between the at least one of the plurality of column electrodes and the at least one of the plurality of row electrodes.

4. The mobile communication device of claim 3, where a distance between the at least one of the plurality of column electrodes and the at least one of the plurality of row electrodes decreases.

5. The mobile communication device of claim 1, where the logic is further configured to:
determine the position of input by identifying a position of the at least one of the plurality of column electrodes and identifying a position of the at least one of the plurality of row electrodes.

6. A method, comprising:
determining a change of current in at least one of a plurality of column electrodes and at least one of a plurality of row electrodes, where the determined change of current is produced when the at least one of a plurality of column electrodes is moved closer to the least one of a plurality of row electrodes;
determining a position of an input on a surface of a display based on identifying a position of the at least one of a plurality of column electrodes and a position of the least one of a plurality of row electrodes; and
activating a display to display information based on the determined position of the input.

7. The method of claim 6, where the at least one of a plurality of column electrodes is moved closer to the least one of a plurality of row electrodes when a user presses down on the surface.

8. The method of claim 6, where the determined change of current in at least one of a plurality of column electrodes and at least one of a plurality of row electrodes is an increase of current.

9. The method of claim 8, where the increase of current is produced by a decreased resistance between the at least one of a plurality of column electrodes and the least one of a plurality of row electrodes.

10. The method of claim 9, where current flows through a conducting liquid and the at least one of a plurality of column electrodes and the least one of a plurality of row electrodes.

11. A device, comprising:
means for displaying information on a surface;
means for determining a position of an input on the surface by monitoring current through a conducting liquid located beneath the surface; and
means for displaying information based on the determined position of the input.

12. The device of claim 11, where the means for displaying information includes a liquid crystal display (LCD).

13. The device of claim 11, where the means for determining a position of the input on the surface includes a plurality of column electrodes and a plurality of row electrodes.

14. The device of claim 13, where the means for determining a position of the input on the surface includes:
means for identifying a position of a column electrode and a position of a row electrode.

15. The device of claim 14, where the means for determining a position of the input on the surface includes:
means for determining an amount of current through the plurality of column electrodes and the plurality of row electrodes.

16. A device, comprising:
a touch sensitive display assembly comprising:
a display;
a top substrate including a plurality of column electrodes;
a bottom substrate including a plurality of row electrodes; and
logic configured to:
determine an input position on the top substrate based on an increase of current through one of the column electrodes and an increase of current through one of the row electrodes, and
control the display to display information based on the determined input position.

17. The device of claim 16, further comprising:
a conducting liquid between the column electrodes and the row electrodes.

18. The device of claim 17, where a resistance provided by the conducting liquid decreases when the one of the column electrodes is moved closer to the one of the row electrodes.

19. The device of claim 18, where the logic is further configured to:
determine an amount of current through each of the plurality of column electrodes and each of the plurality of row electrodes.

20. The device of claim 19, where the logic is further configured to:
compare the determined amount of current through each of the plurality of column electrodes and the plurality of row electrodes to a predetermined value of current.
